(19) United States
(12) Patent Application Publication
(10) Pub. No.: US 2018/0111571 A1
(43) Pub. Date: Apr. 26, 2018

(54) VEHICULAR UNDERCOVER AND MANUFACTURING METHOD THEREOF

(71) Applicant: HAYASHI TELEMPU CORPORATION, Nagoya-shi (JP)

(72) Inventors: Hiromichi MIYANO, Aichi (JP); Hirofumi OTSUKA, Aichi (JP)

(73) Assignee: HAYASHI TELEMPU CORPORATION

(21) Appl. No.: 15/786,600

(22) Filed: Oct. 18, 2017

(30) Foreign Application Priority Data
Oct. 26, 2016 (JP) 2016-209148

(51) Int. Cl. B60R 13/08; B32B 27/12; B32B 7/12; B32B 5/08; B32B 5/02

(52) U.S. Cl. CPC B60R 13/0861; B32B 27/12; B32B 5/024; B32B 5/08; B32B 5/022; B32B 7/12

(57) ABSTRACT

The present invention discloses an integrally press-molded vehicular undercover. The undercover includes a needle-punched first fiber layer containing a first inorganic fiber and a first solidified thermoplastic binder and a needle-punched second fiber layer containing a second inorganic fiber and a second solidified thermoplastic binder. The first fiber layer and the second fiber layer are adhered to each other in a state that the undercover has a weak layer between the first fiber layer and the second fiber layer.

### CROSS-REFERENCES TO RELAYED APPLICATIONS

The present application is related to the Japanese Patent Application No. 2016-209148, filed Oct. 26, 2016, the entire disclosure of which is expressly incorporated by reference herein.

### BACKGROUND OF THE INVENTION

### 1. Field of the Invention

The present invention relates to a press-molded vehicular undercover and a manufacturing method thereof.

### 2. Description of the Related Art

For example, vehicular undercovers such as an engine undercover, a floor undercover and the like are installed under a vehicle body for improving quietness inside a vehicle and for other purposes.

Japanese Patent Application Publication No. 2006-240408 discloses an automobile undercover integrally formed by providing reinforcing layers of olefin-based resin on both surfaces of a single layered core material made by mixing fiberglass and olefin-based resin.

When the undercover is formed by integrally press-molding the fiber material including the single-layered core material made by mixing fiberglass and olefin-based resin, it is not easy to ensure a thickness of the undercover.

### BRIEF SUMMARY OF THE INVENTION

The present invention discloses a vehicular undercover and a manufacturing method of the vehicular undercover, the undercover being obtained by a low-cost manufacturing method, the undercover having a required thickness.

One embodiment of the present invention provides an integrally press-molded vehicular undercover, comprising: a needle-punched first fiber layer containing a first inorganic fiber and a first solidified thermoplastic binder; and a needle-punched second fiber layer containing a second inorganic fiber and a second solidified thermoplastic binder, wherein the first fiber layer and the second fiber layer are adhered to each other in a state that the undercover has a weak layer between the first fiber layer and the second fiber layer.

In addition, another embodiment of the present invention provides a manufacturing method of a vehicular undercover, the method comprising: a step of obtaining a layered material by putting together a needle-punched first fiber material containing a first inorganic fiber and a first thermoplastic binder and a needle-punched second fiber material containing a second inorganic fiber and a second thermoplastic binder; and a step of forming the undercover including a first fiber layer made of the first fiber material and a second fiber layer made of the second fiber material by heating and press-molding the layered material, wherein the first fiber layer and the second fiber layer are adhered to each other in a state that the undercover has a weak layer between the first fiber layer and the second fiber layer.

These and other features, aspects, and advantages of the invention will be apparent to those skilled in the art from the following detailed description of preferred non-limiting exemplary embodiments, taken together with the drawings and the claims that follow.

### BRIEF DESCRIPTION OF THE DRAWINGS

FIG. 1 is a side view schematically showing an example of an automobile having an undercover.

FIG. 2 is a bottom view schematically showing an example of an automobile having the undercover.

FIG. 3 is a cross-sectional view schematically showing an example of a vertical cross-section of the undercover.

FIG. 4 is a cross-sectional view schematically showing an example of a vertical cross-section of a fiber material.

FIG. 5 is a cross-sectional view schematically showing an example of a vertical cross-section of a skin material.

FIGS. 6A to 6D are cross-sectional views schematically showing examples of vertical cross-sections of other undercovers.

FIG. 7 is a bottom view schematically showing an example of the undercover.

FIG. 8 is a drawing schematically showing an example of a vertical end of the undercover cut at the position corresponding to A1-A1 in FIG. 7.

FIG. 9 is a drawing schematically showing an example of a manufacturing method of the undercover.

### DETAILED DESCRIPTION OF THE INVENTION

Hereafter, embodiments of the present invention will be explained. Of course, the below-described embodiments merely exemplify the present invention. All features disclosed in the embodiments are not necessarily essential for solving the present invention. In the present application, “Min to Max” means that a value is equal to or more than the minimum value “Min” and equal to or less than the maximum value “Max”.

(1) Outline of Technology Included in the Present Invention

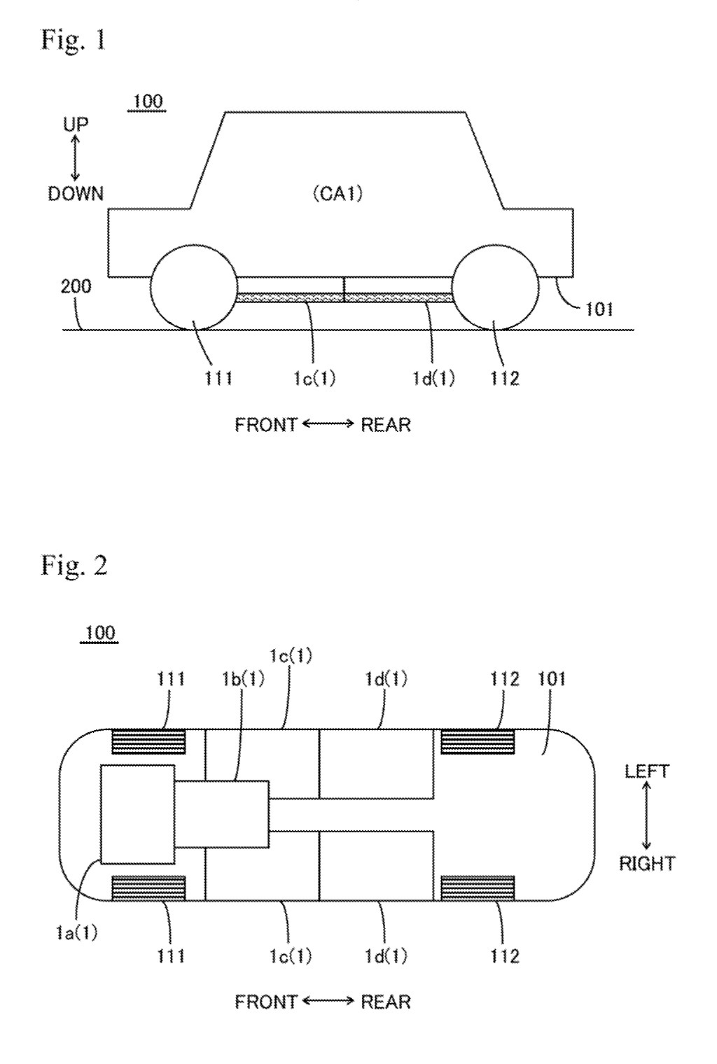

First, with reference to the examples shown in FIGS. 1 to 9, an outline of the technology included in the present invention will be explained. Note that the drawings of the present application schematically show the examples. Thus, magnification ratios of each of the directions shown in the drawings may be different, and each of the drawings may not fit together. Of course, each element of the present technology is not limited to the concrete examples indicated by the reference letters.

### Embodiment 1

A vehicular undercover 1 concerning one embodiment of the present technology has a first fiber layer 10 and a second fiber layer 20, and the vehicular undercover 1 is integrally press-molded. The first fiber layer 10 includes an inorganic fiber 11 and a solidified thermoplastic binder 12, and the first fiber layer 10 is needle-punched. The second fiber layer 20 includes an inorganic fiber 21 and a solidified thermoplastic binder 22, and the second fiber layer 20 is also needle-punched. In the vehicular undercover 1, the first fiber layer 10 and the second fiber layer 20 are adhered to each other in a state that the undercover 1 has a weak layer 30 between the first fiber layer 10 and the second fiber layer 20.

Although a thickness is limited in a needle-punched fiber layer, since the first fiber layer 10 and the second fiber layer 20 which are independently needle-punched are adhered to each other in the state that the undercover 1 has the weak layer 30 between the first fiber layer 10 and the second fiber layer 20, the thickness of the undercover 1 can be easily ensured. Accordingly, the present embodiment can provide a vehicular undercover obtained by a low-cost manufacturing method, the undercover having a required thickness.

Here, the inorganic fiber includes a glass fiber, a carbon fiber, a silicon carbide fiber, an alumina fibers, a ceramic fiber, a rock fiber and a slag fiber, for example.

The thermoplastic binder can be fibrous or nonfibrous.

The first fiber layer can include other materials than the inorganic fiber and the thermoplastic binder. The second fiber layer can also include other materials than the inorganic fiber and the thermoplastic binder. The first fiber layer and the second fiber layer can have the same composition or different composition. The first fiber layer and the second fiber layer can have the same thickness or different thickness.

The weak layer means a layer that is peeled off when the vehicular undercover is pulled in a thickness direction of the vehicular undercover.

The vehicular undercover can include other layers such as another needle-punched fiber layer containing an inorganic fiber and a solidified thermoplastic binder, a skin layer or the like.

### Embodiment 2

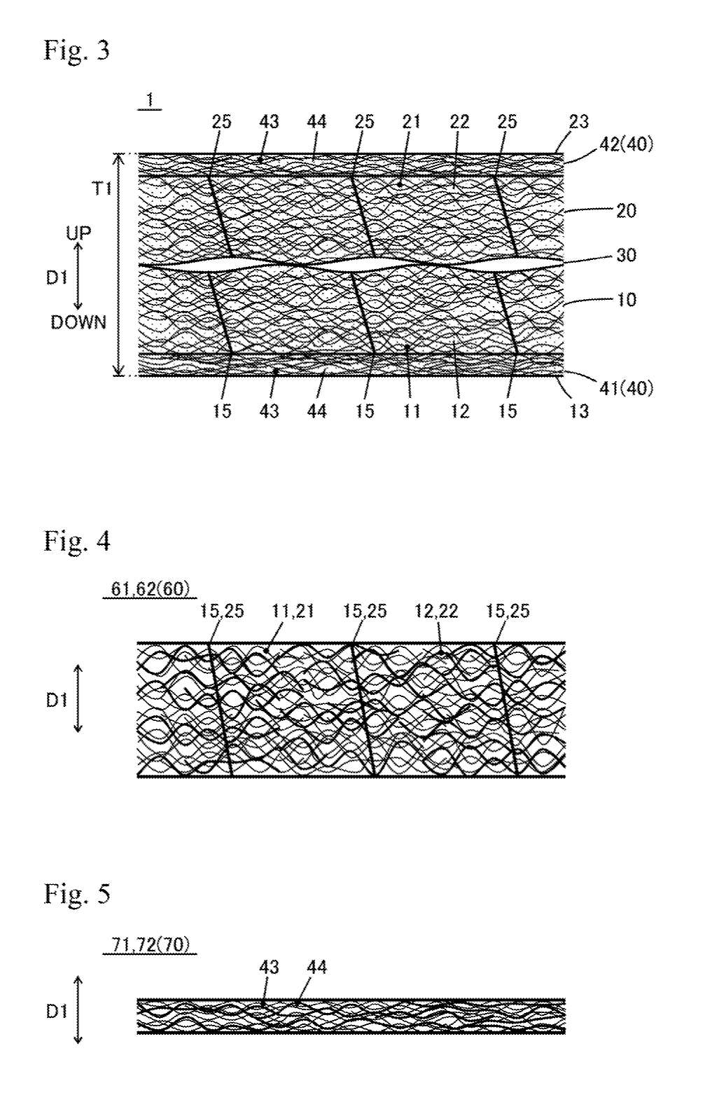

As exemplified, for example, in FIG. 3, the vehicular undercover 1 can have a skin layer 40 on at least one of a surface 23 of a vehicle body 101 side and a surface 13 of the vehicle outer side, the skin layer 40 containing a synthetic resin fiber 43 and a solidified thermoplastic binder 44. The above described embodiment can provide a vehicular undercover capable of improving aerodynamic performance and ice accretion resistance since the skin layer 40 containing the synthetic resin fiber 43 and the thermoplastic binder 44 is on the surface.

Here, the skin layer can be adhered to an opposite surface of the weak layer in the first fiber layer, or can be adhered to the first fiber layer side via another layer. In addition, the skin layer can be adhered to an opposite surface of the weak layer in the second fiber layer, or can be adhered to the second fiber layer side via another layer.

Even when the skin layer is not provided on the vehicular undercover, the undercover is also included in the present technology.

### Embodiment 3

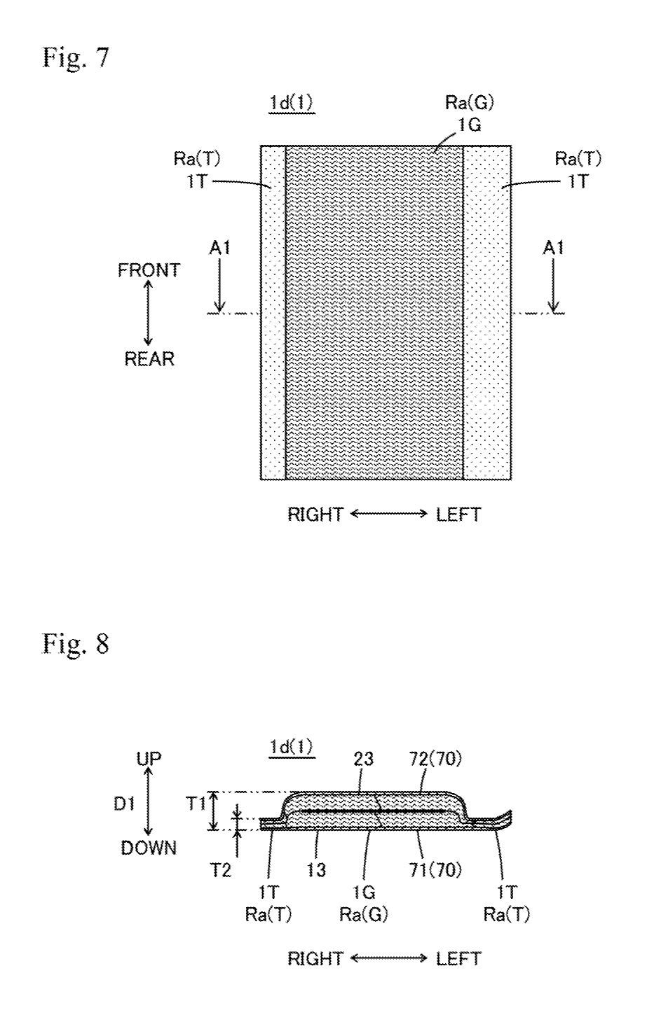

As exemplified in FIGS. 7 and 8, the vehicular undercover 1 can include a thickness-reduced portion 1T being partly thinned in the undercover 1 and a general portion 1G being around the thickness-reduced portion 1T. An arithmetic mean roughness Ra(T) of the vehicle outer side surface 13 of the thickness-reduced portion 1T can be smaller than an arithmetic mean roughness Ra(G) of the vehicle outer side surface 13 of the general portion 1G. The above described embodiment can provide a vehicular undercover capable of improving durability since the undercover 1 is hard to be torn off when the vehicle runs on an obstacle such as a curbstone or the like and the undercover 1 is sandwiched between vehicle components and the obstacle.

Here, the arithmetic mean roughness is an average value of an absolute value of deviation from the centerline of a roughness curve. Specifically, the arithmetic mean roughness is the arithmetic mean roughness Ra defined in JIS B0601: 2013 (Geometrical Product Specifications (GPS)-Surface texture: Profile method-Terms, definitions and surface texture parameters).

Even when the thickness-reduced portion is not provided on the vehicular undercover, the undercover is also included in the present technology.

### Embodiment 4

One embodiment of the present technology provides a manufacturing method of a vehicular undercover 1, the method comprising: a step of obtaining a layered material 50 by putting together a needle-punched first fiber material 61 containing an inorganic fiber 11 and a thermoplastic binder 12 and a needle-punched second fiber material 62 containing an inorganic fiber 21 and a thermoplastic binder 22; and a step of forming the undercover including a first fiber layer 10 made of the first fiber material 61 and a second fiber layer 20 made of the second fiber material 62 by heating and press-molding the layered material 50, wherein the first fiber layer 10 and the second fiber layer 20 are adhered to each other in a state that the undercover 1 has a weak layer 30 between the first fiber layer 10 and the second fiber layer 20.

Even when the needle-punched fiber material is heated, an expansion in the thickness direction D1 is limited. However, when the layered material 50 formed by putting together the first fiber material 61 and the needle-punched second fiber material 62, which are separately needle-punched, are heated, the first fiber layer 10 and the second fiber layer 20 are separately expanded within the limitation and adhered to each other in a state that the undercover 1 has the weak layer 30 between the first fiber layer 10 and the second fiber layer 20. Accordingly, the present embodiment can provide a vehicular undercover having a required thickness by a low-cost manufacturing method.

(2) Concrete Example of Configuration of Automobile Having Vehicular undercover

FIGS. 1 and 2 schematically show an example of an automobile having an undercover. An automobile 100 shown in FIGS. 1 and 2 is a road running vehicle designed and equipped for running on the road. The automobile 100 is a passenger automobile having a vehicle compartment CA1 surrounded by a vehicle body 101. In the figures, FRONT, REAR, LEFT, RIGHT, UP and DOWN respectively represent the front, rear, left, right, up and down side of the automobile. Positional relation of the left and right is based on a direction of viewing the front when seated on a driver's seat in the vehicle compartment CA1. In the automobile 100 shown in FIG. 1, tires 111 of the front wheels and tires 112 of the rear wheels are in contact with a road surface 200.

A vehicular undercover 1 is attached under the vehicle body 101 so as not to come into contact with the road surface 200. The undercover 1 has a function of reducing air resistance (improving fuel efficiency) under the vehicle body 101 when the vehicle is running, a function of protecting the vehicle body 101 from foreign matters such as flipped stones or the like when the vehicle is running, and a function of absorbing and insulating sound to improve silence of the vehicle compartment CA1.

The undercover 1 shown in FIG. 2 is divided into a plurality of undercovers 1a, 1b, 1c, 1c, 1d and 1d. An engine undercover 1a is arranged under an engine of the automobile 100 between the tires 111, 111 of the left and right front wheels. A mission cover 1b is arranged under a speed changer (transmission) of the automobile 100 on the rear side of the engine undercover 1a. Left and right front floor undercovers 1c, 1c are arranged under a floor panel of the automobile 100 on the rear side of the tires 111, 111 of the front wheels. Left and right rear floor undercovers 1d, 1d are arranged under the floor panel of the automobile 100 on the front side of the tires 112, 112 of the rear wheels and the rear side of the front floor undercovers 1c, 1c.

FIG. 3 schematically shows an example of a vertical cross-section of the undercover 1. FIG. 4 schematically shows an example of a vertical cross-section of a fiber material 60 for forming the fiber layers 10, 20. FIG. 5 schematically shows an example of a vertical cross-section of a skin material 70 for forming the skin layer 40. The cross-sections of the examples shown in FIGS. 3 to 5 are exaggeratedly shown to make the explanation easier. Note that a skin layer 41 of the vehicle outer side and a skin layer 42 of the vehicle body 101 side are collectively called a skin layer 40. A first fiber material 61 for forming the first fiber layer 10 and a second fiber material 62 for forming the second fiber layer 20 are collectively shown as a fiber material 60 in FIG. 4 since the same material can be used for both fiber materials. A skin material 71 for forming the skin layer 41 of the vehicle outer side and a skin material 72 for forming the skin layer 42 of the vehicle body side are collectively shown as a skin material 70 in FIG. 5 since the same material can be used for both skin materials. A reference letter D1 shown in FIGS. 3 to 5 is a thickness direction of the undercover 1, a thickness direction of the layers 41, 10, 20 and 42, a thickness direction of the fiber material 60, and a thickness direction of the skin material 70.

The press-molded first fiber layer 10 contains inorganic fibers 11 and a solidified thermoplastic binder 12. The press-molded first fiber layer 10 is needle-punched. In FIG. 3, the inorganic fibers 11 are shown by thin lines and the solidified thermoplastic binder 12 is formed around the inorganic fibers 11. A needle-punched mark 15 is also formed on the first fiber layer 10 so as to connect the surface of the vehicle outer side (contact surface with the skin layer 41) with the surface of the vehicle body side (contact surface with the second fiber layer 20). Since the first fiber layer 10 has air permeability, air can flow in the thickness direction D1. Thus, sound absorption property can be obtained. Here, having air permeability means that air-permeability according to the A method (fragile form method) defined in JIS L1096: 2010 (Testing methods for woven and knitted fabrics) is larger than 1 cc/cm²/sec (preferably 3 cc/cm²/sec or more).

The press-molded second fiber layer 20 contains inorganic fibers 21 and a solidified thermoplastic binder 22. The press-molded second fiber layer 20 is needle-punched. In FIG. 3, the inorganic fibers 21 are shown by thin lines and the solidified thermoplastic binder 22 is formed around the inorganic fibers 21. A needle-punched mark 25 is also formed on the second fiber layer 20 so as to connect the surface of the vehicle outer side (contact surface with the first fiber layer 10) with the surface of the vehicle body side (contact surface with the skin layer 42). Since the second fiber layer 20 has air permeability, air can flow in the thickness direction D1. Thus, sound absorption property can be obtained.

The weak layer 30 is formed between the first fiber layer 10 and the second fiber layer 20. In this state, the first fiber layer 10 and the second fiber layer 20 are adhered to each other. The weak layer 30 means a layer that is peeled off when the undercover 1 is pulled in the thickness direction D1.

On the vehicle outer side surface 13 of the press-molded undercover 1, the skin layer 41 containing the synthetic resin fibers 43 and the solidified thermoplastic binder 44 is formed. In FIG. 3, the synthetic resin fibers 43 are shown by thin lines and the solidified thermoplastic binder 44 is formed around the synthetic resin fibers 43. The skin layer 41 shown in FIG. 3 is adhered to the surface (surface opposite to the weak layer 30) of the vehicle body side in the first fiber layer 10. In many cases, unevenness is formed on the vehicle outer side surface 13 of the undercover 1. Since the skin layer 41 has air permeability, air can flow in the thickness direction D1. Thus, sound absorption property can be obtained.

On the surface 23 of the vehicle body 101 side of the press-molded undercover 1, the skin layer 42 containing the synthetic resin fibers 43 and the solidified thermoplastic binder 44 is formed. In FIG. 3, the synthetic resin fibers 43 are shown by thin lines and the solidified thermoplastic binder 44 is formed around the synthetic resin fibers 43. The skin layer 42 shown in FIG. 3 is adhered to the surface of the vehicle body 101 side (surface opposite to the weak layer 30) in the second fiber layer 20. In many cases, unevenness is formed on the vehicle body side surface 23 of the undercover 1. Since the skin layer 42 has air permeability, air can flow in the thickness direction D1. Thus, sound absorption property can be obtained.

The inorganic fibers 11, 21 of the fiber layers 10, 20 are fibers mainly containing inorganic substance. The inorganic fibers 11, 21 are materials which keep the state of the fibers without being melted even when the fiber material 60 is heated. Hence, the inorganic fibers 11, 21 of the fiber material 60 are kept remained even after press molding. For the inorganic fibers, glass fibers, carbon fibers, silicon carbide fibers, alumina fibers, ceramic fibers, rock fibers and slug fibers can be used, for example. In particular, relatively inexpensive glass fibers are suitable. A diameter of the inorganic fiber is not particularly limited. For example, the diameter can be 5 to 14 μm. A length of the inorganic fiber is not particularly limited. For example, the length can be 5 to 200 mm. A cross-sectional shape of the inorganic fiber is not particularly limited. For example, the cross-sectional shape can be elliptic including circular, triangular, flat or the like.

The thermoplastic binders 12, 22 of the fiber layers 10, 20 are a binder mainly containing thermoplastic adhesive components such as a thermoplastic resin. The thermoplastic binders 12, 22 are a material which is softened when the fiber material 60 for forming the fiber layers 10, 20 is heated and melted when the fiber material 60 is further heated. The thermoplastic binders 12, 22 are melted to adhere the first fiber layer 10 with the second fiber layer 20. For the thermoplastic resin (including thermoplastic elastomer) of the thermoplastic binder, polyolefin resins such as a polypropylene (PP) resin and a polyethylene (PE) resin, modified resins obtained by adding elastomer to the above described synthetic resins, materials obtained by adding additives such as a colorant to the above described synthetic resins can be used, for example. In particular, a relatively inexpensive PP resin is suitable.

The thermoplastic binders 12, 22 of the fiber material 60 for forming the fiber layers 10, 20 can be thermoplastic adhesive fibers such as thermoplastic resin fibers.

Hence, the fibrous thermoplastic binders 12, 22 of the fiber material 60 may be melted and become non-fibrous after press molding. For the adhesive fiber, the above described fibers of the thermoplastic resin (e.g., polyolefin resins such as a PP resin and a PE resin) can be used, for example. Fibers having a conjugate structure such as a core-sheath structure and a side-by-side structure can be also used, for example. A melting point of the adhesive fiber can be 100 to 220° C., for example. A fineness of the adhesive fiber is not particularly limited. The fineness can be 2.2 to 16 dtex (decitex), for example. Here, the unit “dtex” means a weight in grams per unit length 10 km. A length of the adhesive fiber is not particularly limited. The length can be 27 to 76 mm, for example. A cross-sectional shape of the adhesive fiber is not particularly limited. For example, the cross-sectional shape can be elliptic including circular, triangular, flat or the like. Since the fiber material 60 has air permeability, air can flow in the thickness direction D1.

Even when the thermoplastic binders 12, 22 of the fiber material 60 are not fibrous, the undercover having the binders is also included in the present technology.

A compounding ratio (hereafter referred to as R1) of the inorganic fibers 11, 21 with respect to the fiber material 60 (i.e., fiber layers 10, 20) can be 10 to 90 wt. %, for example. A compounding ratio (hereafter referred to as R2) of the thermoplastic binders 12, 22 with respect to the fiber material 60 can be 10 to 90 wt. %, for example. However, the following relation is satisfied.

R1+R2≤100 wt. %

Other materials (e.g., fibers) can be added to the fiber material 60 as long as the compounding ratio is within the range of equal to or lower than R1+R2 (more preferably R1+R2≤75 wt. %).

A weight per unit area of the fiber material 60 (i.e., fiber layers 10, 20) can be 250 to 1000 g/m², for example.

Note that kinds of constituent components, the diameters of the fibers, the lengths of the fibers, the cross-sectional shapes of the fibers and the compounding ratios of the constituent components can be same or different between the first fiber material 61 (i.e., first fiber layer 10) and the second fiber material 62 (i.e., second fiber layer 20).

The fiber material 60 can be formed, for example, by mixing the inorganic fibers 11, 21 and fibers containing the fibrous thermoplastic binders 12, 22, arranging the mixture in a mat-shape, and needle-punching it by a needle punching processing machine. Consequently, the needle-punched marks 15, 25 shown in FIG. 4 remain on the cross-sectional surface of the fiber material 60.

The synthetic resin fibers 43 of the skin layer 40 are fibers mainly containing synthetic resins such as a thermoplastic resin. When the synthetic resin fibers 43 are thermoplastic, a melting point of the synthetic resin fibers is preferably higher than a melting point of the thermoplastic binder 44. The synthetic resin fibers 43 having high melting point keep the state of the fibers. Thus, perforation and peeling of the skin layer 40 are prevented. For the thermoplastic resin (including thermoplastic elastomer) of the synthetic resin fibers 43, polyester resins such as a polyethylene terephthalate (PET) resin, polyolefin resins such as a polyamide (PA) resin, an acrylic (PMMA) resin and a PP resin, modified resins obtained by adding elastomer to the above described synthetic resins, materials obtained by adding additives such as a colorant to the above described synthetic resins can be used, for example. In particular, a relatively inexpensive PET resin is suitable. Fibers having a conjugate structure can be also used for the synthetic resin fibers 43. A fineness of the synthetic resin fibers is not particularly limited. The fineness can be 2.2 to 16 dtex, for example. A length of the synthetic resin fibers is not particularly limited. The length can be 27 to 76 mm, for example. A cross-sectional shape of the synthetic resin fibers is not particularly limited. For example, the cross-sectional shape can be elliptic including circular, triangular, flat or the like.

The thermoplastic binder 44 of the skin layer 40 is a binder mainly containing thermoplastic adhesive components such as a thermoplastic resin. The thermoplastic binder 44 is softened when the skin material 70 for forming the skin layer 40 is heated and melted when the skin material 70 is further heated. The thermoplastic binder 44 is melted to form a smooth surface. Thus, ice accretion resistance is improved. In addition, the thermoplastic binder 44 is melted to adhere the skin layer 41 with the first fiber layer 10 well and adhere the skin layer 42 with the second fiber layer 20 well. Thus, chipping resistance (peeling prevention strength) is improved. For the thermoplastic resin (including thermoplastic elastomer) of the thermoplastic binder, polyolefin resins such as a PP resin and a PE resin, modified resins obtained by adding elastomer to the above described synthetic resins, materials obtained by adding additives such as a colorant to the above described synthetic resins can be used, for example. In particular, a relatively inexpensive PP resin is suitable.

The thermoplastic binder 44 of the skin material 70 for forming the skin layer 40 can be thermoplastic adhesive fibers such as thermoplastic resin fibers. Hence, the fibrous thermoplastic binder 44 of the skin material 70 may be melted and become non-fibrous after press molding. For the adhesive fibers, the above described fibers of the thermoplastic resin (e.g., polyolefin resins such as a PP resin and a PE resin) can be used, for example. Fibers having a conjugate structure can be also used. A melting point of the adhesive fibers can be 100 to 220° C., for example. A fineness of the adhesive fibers is not particularly limited. The fineness can be 2.2 to 16 dtex, for example. A length of the adhesive fibers is not particularly limited. The length can be 27 to 76 mm, for example. A cross-sectional shape of the adhesive fibers is not particularly limited. For example, the cross-sectional shape can be elliptic including circular, triangular, flat or the like. Since the skin material 70 has air permeability, air can flow in the thickness direction D1. Even when the thermoplastic binder 44 of the skin material 70 is not fibrous, the undercover having the binder is also included in the present technology.

A compounding ratio (hereafter referred to as R3) of the synthetic resin fibers 43 with respect to the skin material 70 (i.e., skin layer 40) can be 10 to 90 wt. %, for example. A compounding ratio (hereafter referred to as R4) of the thermoplastic binder 44 with respect to the skin material 70 can be 10 to 90 wt. %, for example. However, the following relation is satisfied.

R3+R4≤100 wt. %

Other materials (e.g., fibers) can be added to the skin material 70 as long as the compounding ratio is within the range of equal to or lower than R3+R4 (more preferably R3+R4≤75 wt. %).

A weight per unit area of the skin material 70 (i.e., skin layer 40) can be 100 to 300 g/m², for example.

Note that kinds of constituent components, the diameters of the fibers, the lengths of the fibers, the cross-sectional shapes of the fibers and the compounding ratios of the constituent components can be same or different between the skin material 71 of the vehicle outer side (i.e., skin layer 41) and the skin material 72 of the vehicle body side (i.e., skin layer 42).

The skin material 70 can be also needle-punched. In this case, the skin material 70 can be formed, for example, by mixing the synthetic resin fibers 43 and fibers containing the fibrous thermoplastic binder 44, arranging the mixture in a mat-shape, and needle-punching it by a needle punching processing machine.

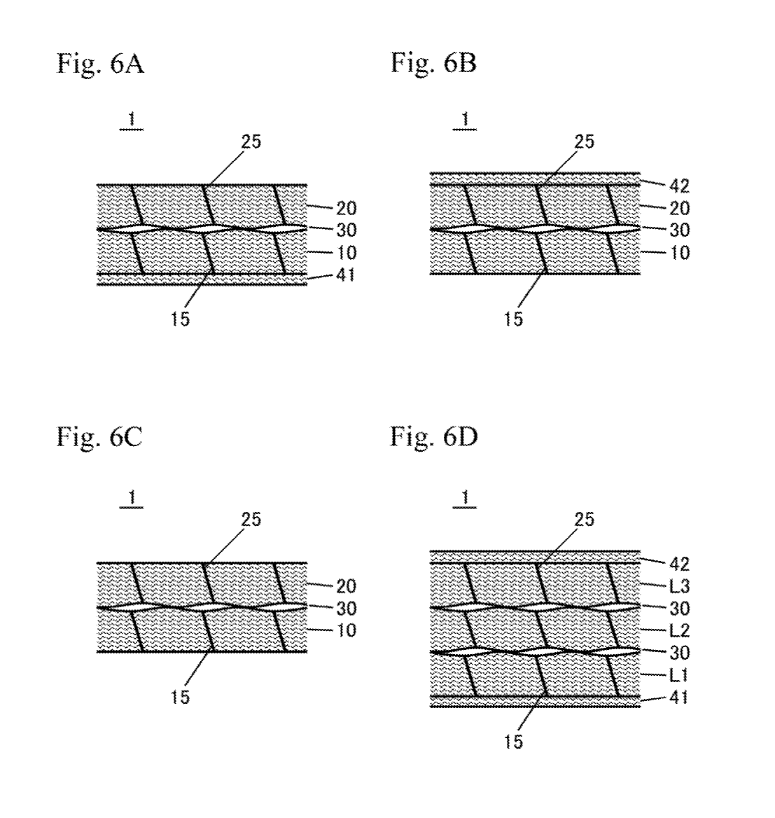

Even when at least one of the skin layers 41 and 42 is not provided on the undercover, the undercover is also included in the present technology. FIG. 6A schematically shows an example of a vertical cross-section of the undercover 1 having the skin layer 41 of the vehicle outer side and without having the skin layer of the vehicle body side. FIG. 6B schematically shows an example of a vertical cross-section of the undercover 1 having the skin layer 42 of the vehicle body side and without having the skin layer of the vehicle outer side. FIG. 6C schematically shows an example of a vertical cross-section of the undercover 1 without having both the skin layers 41 and 42. Of course, the cross-sections of the examples shown in FIGS. 6A to 6D (also in FIG. 6D) are exaggeratedly shown to make the explanation easier.

Even when three or more needle-punched fiber layers containing inorganic fibers and a solidified thermoplastic binder are provided, the undercover having the three or more needle-punched fiber layers is also included in the present technology. FIG. 6D schematically shows an example of a vertical cross-section of the undercover 1 having needle-punched fiber layers L1, L2, L3 containing inorganic fibers and a solidified thermoplastic binder. In this example, the fiber layers L1 and L2 are adhered to each other in a state that the weak layer 30 is formed between the fiber layer L1 and the fiber layer L2, and the fiber layers L2 and L3 are adhered to each other in a state that the weak layer 30 is formed between the fiber layer L2 and the fiber layer L3. Accordingly, when the fiber layer L1 corresponds to the first fiber layer 10, the fiber layer L2 corresponds to the second fiber layer 20. When the fiber layer L2 corresponds to the first fiber layer 10, the fiber layer L3 corresponds to the second fiber layer 20.

A thickness of the press-molded undercover 1 can be 1 to 12 mm, for example. (A thickness T1 of the general portion is shown in FIG. 3.) A thickness T2 of the general portion 1G (shown in FIGS. 7 and 8) of the undercover 1 can be 3 to 12 mm, for example.

The rigidity of the undercover is approximately proportional to the cube of the thickness of the undercover. Here, as a core layer except for the skin layer, if only one needle-punched fiber layer including inorganic fibers and a thermoplastic binder is formed, the thickness of the undercover is limited. Alternatively, if the core layer is formed by foamed resins, the cost of foaming agent is high. Consequently, the cost of the product becomes high.

In the undercover 1 of the present concrete example, the needle-punched fiber layers 10, 20 which are independently needle-punched are adhered to each other in the state that the weak layer 30 is formed between them. Thus, the thickness can be easily ensured.

A density of the press-molded undercover 1 can be, for example, 0.05 to 0.5 g/cm³ (more preferably 0.1 to 0.3 g/cm³).

As shown in FIGS. 7 and 8, a thickness of the press-molded undercover 1 can be partly different. FIG. 7 schematically shows a bottom surface (vehicle outer side surface) of undercover 1 using a rear floor undercover 1d of the left side as an example. FIG. 8 schematically shows a vertical end of the undercover 1 cut at the position corresponding to A1-A1 in FIG. 7 using the rear floor undercover 1d of the left side as an example.

The undercover 1 shown in FIGS. 7 and 8 includes a thickness-reduced portion 1T configured to be partly thinned and a general portion 1G formed around the thickness-reduced portion 1T. Namely, a thickness T2 of the thickness-reduced portion 1T is smaller than a thickness T1 of the general portion 1G which occupies a large portion of the undercover 1. In the undercover 1, the thickness-reduced portion 1T is located at the position easily sandwiched between vehicle components and an obstacle such as a curbstone or the like when the vehicle runs on the obstacle. For example, the thickness-reduced portion 1T is located on a terminal portion and a fastening portion fastened to the vehicle components. The thickness T2 of the thickness-reduced portion 1T can be specified within the range thinner than the thickness T1 of the general portion 1G. The thickness T2 can be 1 to 3 mm, for example.

In addition, the arithmetic mean roughness Ra(T) of the vehicle outer side surface 13 in the thickness-reduced portion 1T is smaller than the arithmetic mean roughness Ra(G) of the vehicle outer side surface 13 in the general portion 1G. Consequently, on the vehicle outer side surface 13 of the undercover 1, the thickness-reduced portion 1T has higher glossiness of the synthetic resin than the general portion 1G, has smaller dynamic friction force against the contact of the obstacle such as a curbstone or the like, and is hard to be torn off when sandwiched between the vehicle components and the obstacle. The arithmetic mean roughness Ra(G) of the vehicle outer side surface 13 of the general portion 1G can be 1.5 to 5 μm, for example. The arithmetic mean roughness Ra(T) of the vehicle outer side surface 13 of the thickness-reduced portion 1T can be specified within the range smaller than Ra(G). The arithmetic mean roughness Ra(T) can be 0.5 to 1.5 μm, for example.

(3) Concrete Example of Manufacturing Method of Vehicular Undercover, Operation and Effect

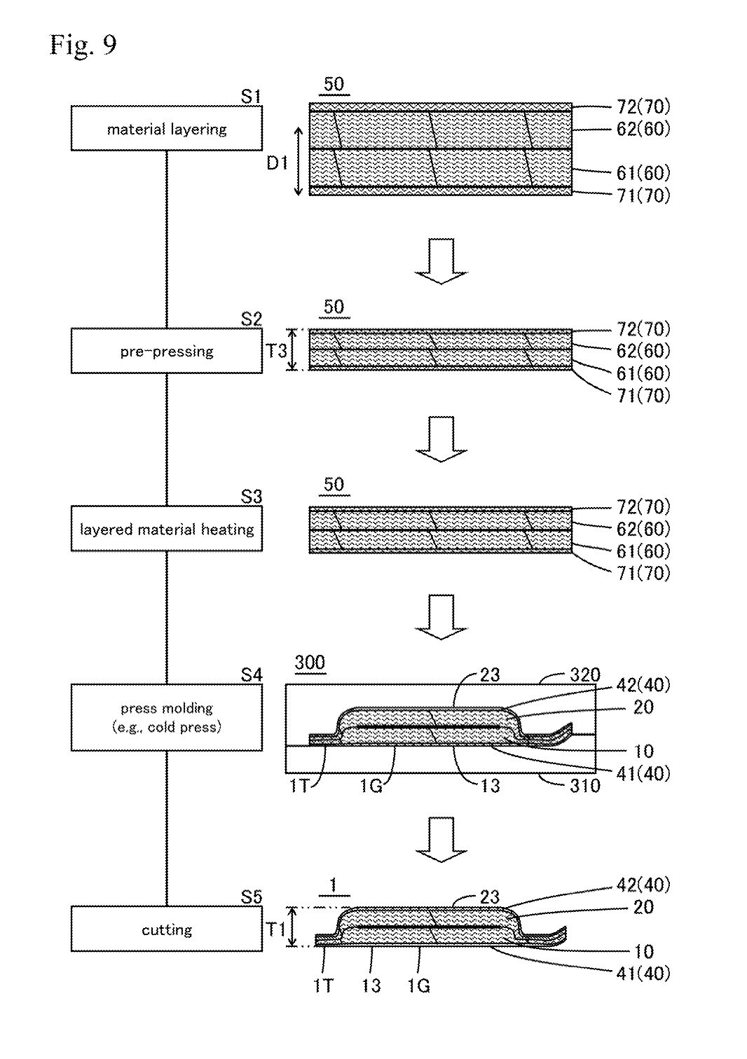

Next, with reference to FIG. 9 and other figures, an example of the manufacturing method of the undercover 1 will be explained.

FIG. 9 shows a concrete example of manufacturing the undercover 1 having the layers 41, 10, 20 and 42 shown in FIG. 3. In the manufacturing method shown in FIG. 9, first of all, a skin material 71, a needle-punched first fiber material 61, a needle-punched second fiber material 62 and a skin material 72 for respectively forming layers 41, 10, 20 and 42 are sequentially layered (material layering step S1).

In the present concrete example, the layered material 50 obtained by the material layering step S1 is heated by a pre-heating device to above a melting point of the thermoplastic binders 12, 22, 44 and pressed by a pre-pressing device in the thickness direction D1 (pre-pressing step S2). Consequently, at least a part of the thermoplastic binders 12, 22 and 44 is once melted to adhere the materials 71, 61, 62 and 72 to each other. Thus, the layered material 50 is integrated and easily operable. When the temperature of the integrated layered material 50 is reduced lower than the softening temperature of the thermoplastic binders 12, 22 and 44, the thermoplastic binders 12, 22 and 44 are solidified. Thus, the layered material 50 is kept in a state that it is integrated. Here, a thickness of the integrated layered material 50 is referred to as T3. The thickness T3 of the layered material 50 with respect to the thickness T1 of the general portion 1G can be targeted to the following formula, for example.

0.5×T1≤T3≤1.5×T1

Then, the integrated layered material 50 is heated by a heating device to above the melting point of the thermoplastic binders 12, 22 and 44 (layered material heating step S3). Consequently, at least a part of the thermoplastic binders 12, 22 and 44 is melted, and the fiber materials 61, 62 start to expand in the thickness direction D1 by a restoring force of the inorganic fibers 11, 21 of the fiber materials 61, 62 compressed in the thickness direction D1. However, since the fiber materials 61, 62 themselves are needle-punched, the restoration of the thickness is limited. On the other hand, a part between the first fiber material 61 and the second fiber material 62 is easily expanded in the thickness direction D1 since the part is not restrained by the needle punch. Thus, the weak layer 30 shown in FIG. 3 is formed.

The heating of the step S3 and the pre-heating step S2 can be a radiation heating performed by an infrared radiation heater, a hot air heating performed by a suction heater (hot air circulation heater), a contact heating of hot press, or the combination of the above described heating methods, for example.

After the layered material heating step S3, the heated layered material 50 is press-molded by a press molding apparatus 300 (press molding step S4). The press molding apparatus 300 has a die 310 and a die 320. The die 310 forms a surface 13 having the unevenness of the vehicle outer side of the undercover 1. The die 320 forms a surface 23 having the unevenness of the vehicle body 101 side of the undercover 1. Although the die 310 is a lower die and the die 320 is an upper die in FIG. 9, it is also possible to use the die 310 as an upper die and use the die 320 as a lower die. For the press-molding, cold press can be used but hot press can be also used. Since the part between the first fiber material 61 and the second fiber material 62 is not restrained by the needle punch, the weak layer 30 shown in FIG. 3 is remained between the first fiber layer 10 and the second fiber layer 20. Consequently, the undercover 1 in which the first fiber layer 10 and the second fiber layer 20 are adhered to each other is formed in the state that the weak layer 30 is formed between the first fiber layer 10 made of the first fiber material 61 and the second fiber layer 20 made of the second fiber material 62. When the temperature of the undercover 1 becomes lower than the softening temperature of the thermoplastic binders 12, 22 and 44, the thermoplastic binders 12, 22 and 44 are solidified and the shape of the undercover 1 is maintained.

Here, since the density of the thermoplastic binders 12, 22 and 44 is high in the thickness-reduced portion 1T, a large amount of melted thermoplastic binder is leaked to the surface 13 of the vehicle outer side and the surface 23 of the vehicle body 101 side. Consequently, the thickness-reduced portion 1T is smoother than the general portion 1G. In addition, the arithmetic mean roughness Ra(T) of the surface 13 of the vehicle outer side of the thickness-reduced portion 1T is smaller than the arithmetic mean roughness Ra(G) of the surface 13 of the vehicle outer side of the general portion 1G. As an outer appearance, the thickness-reduced portion 1T has higher glossiness of the synthetic resin than the general portion 1G.

Note that an outer periphery of the press molded article can be cut by a cutting machine if required (cutting step S5). As a method of cutting, a cutting by a cutting blade, a water jet cutting and a manual cutting using a cutter can be used, for example.

As explained above, the undercover 1 shown in FIG. 3 having the weak layer 30 between the first fiber layer 10 and the second fiber layer 20 can be manufactured. Of course, the undercovers 1 shown in FIGS. 6A to 6D can be manufactured by the same manufacturing method.

As explained above, even when the needle-punched fiber material is heated, an expansion in the thickness direction D1 is limited. For example, it is supposed that a needle-punched fiber layer containing inorganic fibers and a thermoplastic binder is only one layer, the thickness of the layer is limited to 3 mm, and thicknesses of the skin layers of both sides are 0.5 mm. In this case, the thickness of the general portion of the undercover is limited to 3+2×0.5=4 mm.

On the other hand, as shown in the present concrete example, it is supposed that the needle-punched fiber layers 10, 20 containing inorganic fibers and a thermoplastic binder are two layers, a thickness of each fiber layers 10, 20 is limited to 3 mm, the thickness of the weak layer 30 expanded in the thickness direction D1 is 0.5 mm, and the thicknesses of the skin layers 41, 42 of both sides are 0.5 mm. In this case, the thickness of the general portion of the undercover is 2×3+0.5+2×0.5=7.5 mm. Accordingly, the thickness of the undercover is 3.5 mm thicker than the case where the needle-punched fiber layer containing inorganic fibers and a thermoplastic binder is only one layer. Furthermore, the increase in the thickness of the undercover exceeds the thickness 3 mm of the needle-punched fiber layer.

In the present concrete example, the separately needle-punched first fiber material 61 and second fiber material 62 are adhered to each other in the state that the weak layer 30 expanded in the thickness direction D1 is formed between them. Accordingly, the present concrete example can provide a vehicular undercover having a required thickness by a low-cost manufacturing method. It is preferable that the vehicular undercover is obtained by a low-cost manufacturing method. However, the material itself of the vehicular undercover is not necessarily low-cost.

In addition, the thickness-reduced portion 1T located at the position easily sandwiched between vehicle components and an obstacle when the vehicle runs on the obstacle is smoother than the general portion 1G. Thus, the thickness-reduced portion 1T has smaller dynamic friction force against the contact of the obstacle and is hard to be torn off when sandwiched between the vehicle components and the obstacle.

(4) Practical Examples

Hereafter, although the present invention will be explained concretely showing practical examples, the present invention is not limited to the following examples.

[Practical Examples]

For the first fiber material 61, a needle-punched fiber material (weight per unit area 550 g/m²) containing glass fibers (example of the inorganic fibers 11) and a PP resin (example of the thermoplastic binder 12) was used. For the second fiber material 62, a needle-punched fiber material (weight per unit area 550 g/m²) containing glass fibers (example of the inorganic fibers 12) and a PP resin (example of the thermoplastic binder 22) was used. For the skin material 71 of the vehicle outer side, a nonwoven fabric (weight per unit area 200 g/m²) containing a PET resin (example of the synthetic resin fibers 43) and a PP resin (example of the thermoplastic binder 44) was used. The skin material 72 of the vehicle body side was not used.

The skin material 71, the first fiber material 61 and the second fiber material 62 are sequentially stacked. Then, according to the manufacturing method shown in FIG. 9, a sample of the undercover 1 shown in FIG. 6A was formed so that the thickness T1 of the general portion 1G became 7 mm and the thickness T2 of the thickness-reduced portion 1T became 1.5 mm.

When a cross-section of the sample of the undercover was viewed by a microscope (magnification ratio: 25), the needle-punched marks 15, 25 were confirmed on the first fiber layer 10 and the second fiber layer 20, and the weak layer 30 having few fibers was confirmed between the first fiber layer 10 and the second fiber layer 20. When the sample of the undercover was pulled in the thickness direction D1, the undercover was peeled off at the weak layer 30.

From the above, it was confirmed that a vehicular undercover having a required thickness could be provided by a low-cost manufacturing method.

When the arithmetic mean roughness Ra(G) of the surface 13 of the vehicle outer side of the general portion 1G was calculated, it was 2.32 μm. When the arithmetic mean roughness Ra(T) of the surface 13 of the vehicle outer side of the thickness-reduced portion 1T was calculated, it was 0.98 μm. Accordingly, it was confirmed that a vehicular undercover in which Ra(T)<Ra(G) could be provided by a low-cost manufacturing method.

(5) Variation Example

Various variation examples of the present invention are conceivable.

For example, another layer can be provided between the skin layer 41 and the first fiber layer 10, and another layer can be provided between the second fiber layer 20 and the skin layer 42.

(6) Conclusion

As explained above, various embodiments of the present invention can provide a technology of the vehicular undercover and the manufacturing method of the vehicular undercover and so on, the undercover being obtained by a low-cost manufacturing method, the undercover having a required thickness. Of course, the above-described basic operation and effect can be obtained even with only the components described in the independent claims.

The present invention can be also implemented by replacing the features disclosed in the above-described examples with each other or changing the combinations thereof, and the present invention can be also implemented by replacing the conventional features and the features disclosed in the above-described examples with each other or changing the combinations thereof. The present invention includes these features and the like.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, proximal, distal, etc. have been used for convenience purposes only and are not intended to imply any particular fixed direction or orientation. Instead, they are used to reflect relative locations and/or directions/orientations between various portions of an object.

In addition, reference to “first,” “second,” “third,” and etc. members throughout the disclosure (and in particular, claims) is not used to show a serial or numerical limitation but instead is used to distinguish or identify the various members of the group.

What is claimed is:

1. An integrally press-molded vehicular undercover, comprising:
a needle-punched first fiber layer containing a first inorganic fiber and a first solidified thermoplastic binder; and
a needle-punched second fiber layer containing a second inorganic fiber and a second solidified thermoplastic binder, wherein
the first fiber layer and the second fiber layer are adhered to each other in a state that the undercover has a weak layer between the first fiber layer and the second fiber layer.

2. The vehicular undercover according to claim 1, further comprising
a skin layer on at least one of a vehicle body side surface of the undercover and a vehicle outer side surface of the undercover, the skin layer containing a synthetic resin fiber and a third solidified thermoplastic binder.

3. The vehicular undercover according to claim 1, wherein
the undercover has a thickness-reduced portion being partly thinned in the undercover and a general portion being around the thickness-reduced portion, and
an arithmetic mean roughness of a vehicle outer side surface of the thickness-reduced portion is smaller than an arithmetic mean roughness of a vehicle outer side surface of the general portion.

4. A manufacturing method of a vehicular undercover, the method comprising:
a step of obtaining a layered material by putting together a needle-punched first fiber material containing a first inorganic fiber and a first thermoplastic binder and a needle-punched second fiber material containing a second inorganic fiber and a second thermoplastic binder; and
a step of forming the undercover including a first fiber layer made of the first fiber material and a second fiber layer made of the second fiber material by heating and press-molding the layered material, wherein the first fiber layer and the second fiber layer are adhered to each other in a state that the undercover has a weak layer between the first fiber layer and the second fiber layer.
